(19) United States
(12) Patent Application Publication
(10) Pub. No.: US 2025/0287022 A1
(43) Pub. Date: Sep. 11, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yang WANG, Beijing (CN); Li ZHANG, Los Angeles, CA (US); Kai ZHANG, Los Angeles, CA (US); Zhipin DENG, Beijing (CN)

(21) Appl. No.: 19/217,903

(22) Filed: May 23, 2025

Related U.S. Application Data
(63) Continuation of application No. PCT/CN2023/133439, filed on Nov. 22, 2023.

(30) Foreign Application Priority Data
Nov. 23, 2022 (WO) PCT/CN2022/133639

(51) Int. Cl. H04N 19/186; H04N 19/159; H04N 19/176

(52) U.S. Cl. CPC H04N 19/186; H04N 19/159; H04N 19/176

(57) ABSTRACT

Embodiments of the disclosure provide a solution for video processing. A method for video processing is proposed. The method includes: constructing, for a conversion between a video unit of a video and a bitstream of the video unit, at least one block vector (BV) candidate list for the video unit; utilizing one or more BVs in the at least one BV candidate list for a chroma prediction of the video unit; and performing the conversion based on the chroma prediction of the video unit.

### CROSS REFERENCE

This application is a continuation of International Application No. PCT/CN2023/133439, filed on Nov. 22, 2023, which claims the benefit of International Application No. PCT/CN2022/133639, filed on Nov. 23, 2022. The entire contents of these applications are hereby incorporated by reference in their entireties.

### FIELDS

Embodiments of the present disclosure relates generally to video processing techniques, and more particularly, to intra block copy for chroma.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: constructing, for a conversion between a video unit of a video and a bitstream of the video, at least one block vector (BV) candidate list for the video unit; utilizing one or more BVs in the at least one BV candidate list for a chroma prediction of the video unit; and performing the conversion based on the chroma prediction of the video unit.

In this way, it can improve coding efficiency and coding performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: constructing at least one block vector (BV) candidate list for a video unit of the video; utilizing one or more BVs in the at least one BV candidate list for a chroma prediction of the video unit; and generating the bitstream based on the chroma prediction of the video unit.

In a fifth aspect, a method for storing a bitstream of a video is proposed. The method comprises: constructing at least one block vector (BV) candidate list for a video unit of the video; utilizing one or more BVs in the at least one BV candidate list for a chroma prediction of the video unit; generating the bitstream based on the chroma prediction of the video unit; and storing the bitstream in a non-transitory computer-readable medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates nominal vertical and horizontal locations of 4:2:2 luma and chroma samples in a picture;

FIG. 5 illustrates an example of encoder block diagram;

FIG. 6 illustrates 67 intra prediction modes;

FIG. 7 illustrates reference samples for wide-angular intra prediction;

FIG. 8 illustrates problem of discontinuity in case of directions beyond 450;

FIG. 9 illustrates illustration of motion vector scaling for temporal merge candidate;

FIG. 10 illustrates MMVD Search Point;

FIG. 11 illustrates local illumination compensation;

FIG. 12 illustrates no subsampling for the short side;

FIG. 13 illustrates IBC reference region depending on current CU position;

FIG. 14 illustrates examples of symmetry in screen content pictures;

FIG. 15A illustrates an illustration of BV adjustment for horizontal flip;

FIG. 15B illustrates an illustration of BV adjustment for vertical flip;

FIG. 16 illustrates intra template matching search area used;

FIG. 17 illustrates the five locations in reconstructed luma samples;

FIG. 18 illustrates the prediction process of DBV mode;

FIG. 19 illustrates a flowchart of a method for video processing in accordance with embodiments of the present disclosure;

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

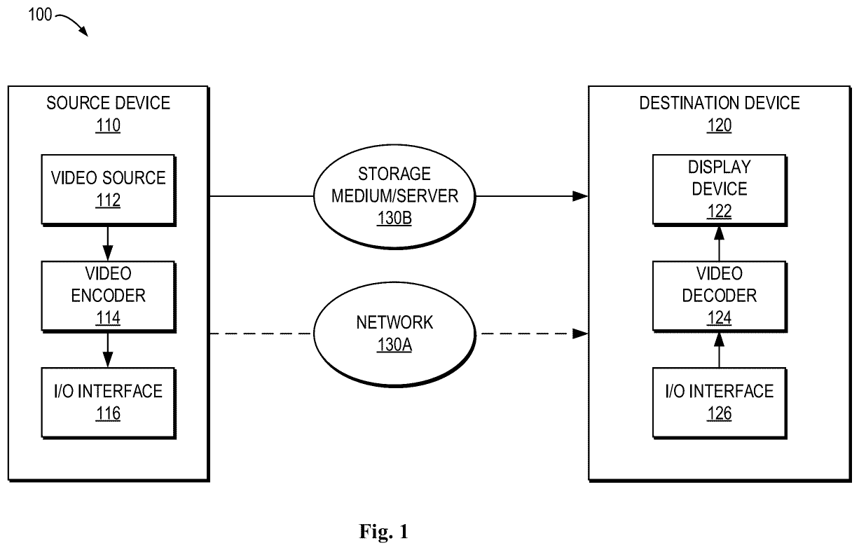

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

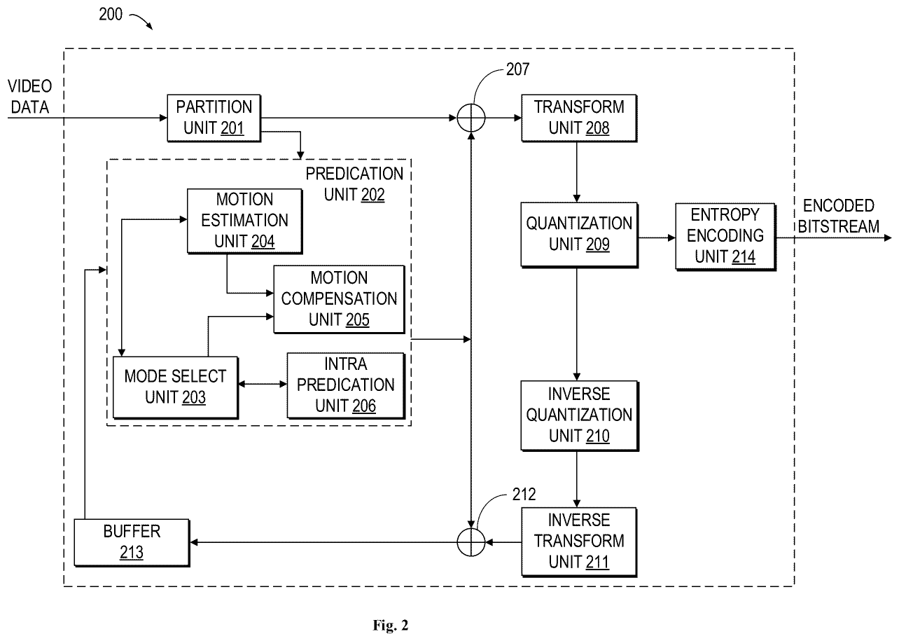

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

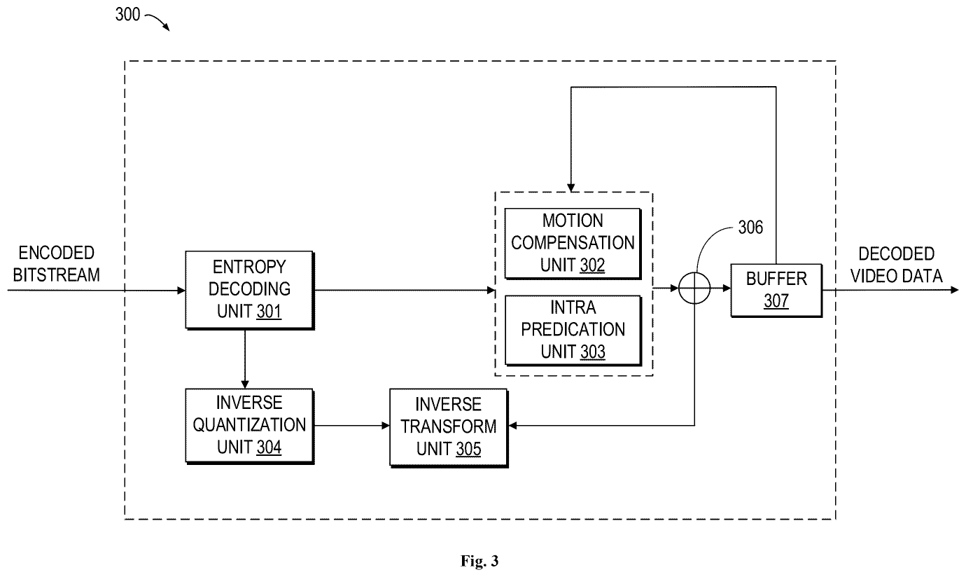

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

The present disclosure is related to video coding technologies. Specifically, it is related to intra block copy (IBC), how to and/or whether to use IBC for chroma prediction, and other coding tools in image/video coding. It may be applied to the existing video coding standard like HEVC, or Versatile Video Coding (VVC). It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

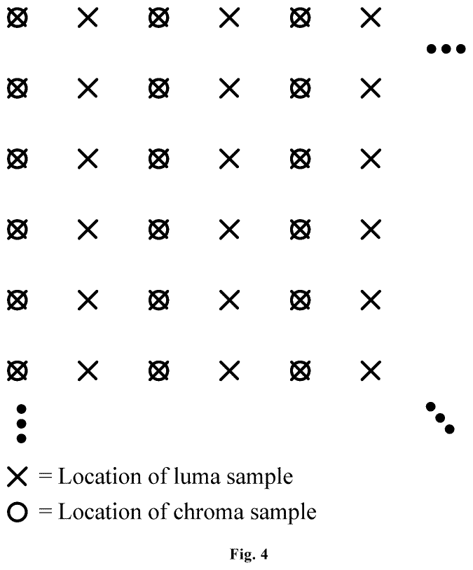

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

TABLE 2-1
SubWidthC and SubHeightC values derived from
chroma_format_idc and separate_colour_plane_flag

| chroma_{—} | separate_colour_{—} | Chroma | | |
|---|---|---|---|---|
| format_idc | plane_flag | format | SubWidthC | SubHeightC |
| 0 | 0 | Mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2. Coding Flow of a Typical Video Codec

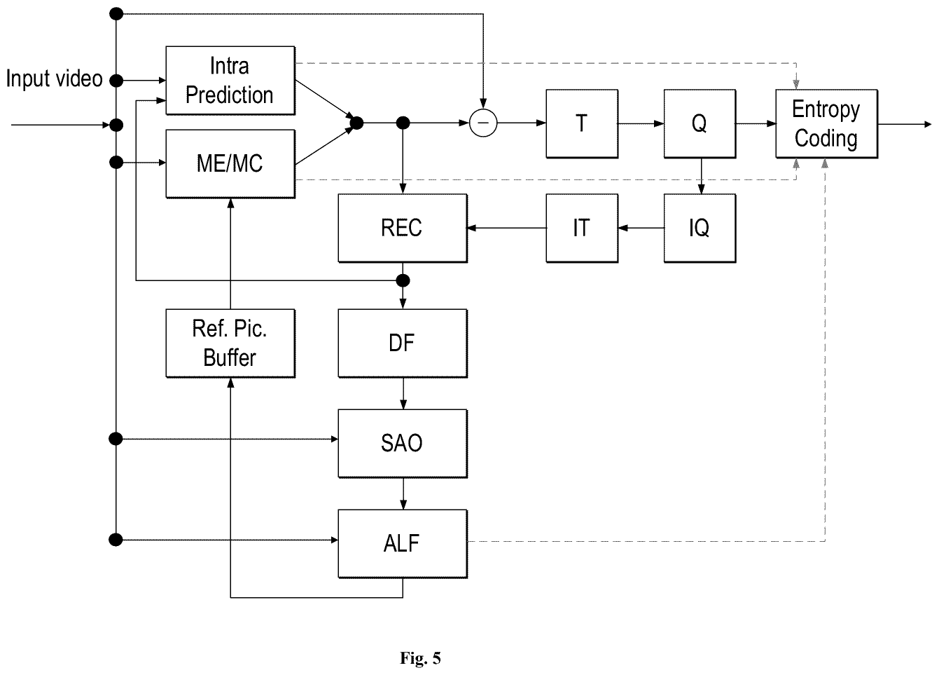

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.3. Intra mode coding with 67 intra prediction modes

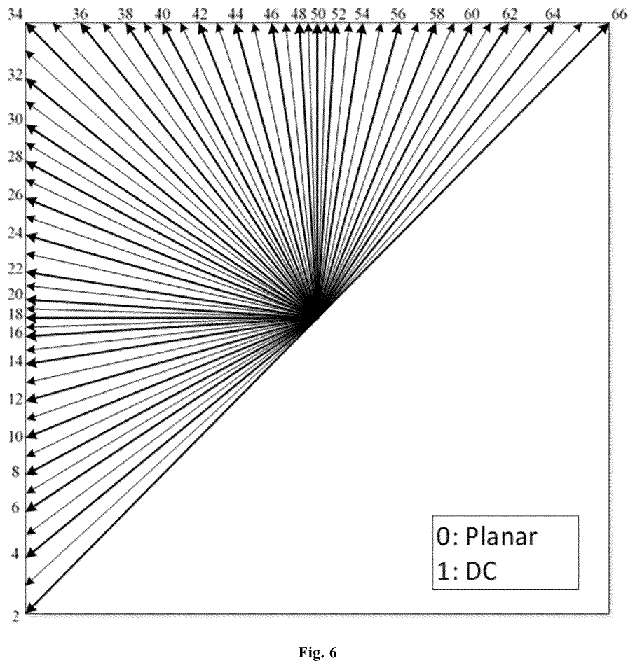

To capture the arbitrary edge directions presented in natural video, the number of directional intra modes is extended from 33, as used in HEVC, to 65, as shown in FIG. 6, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1. Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

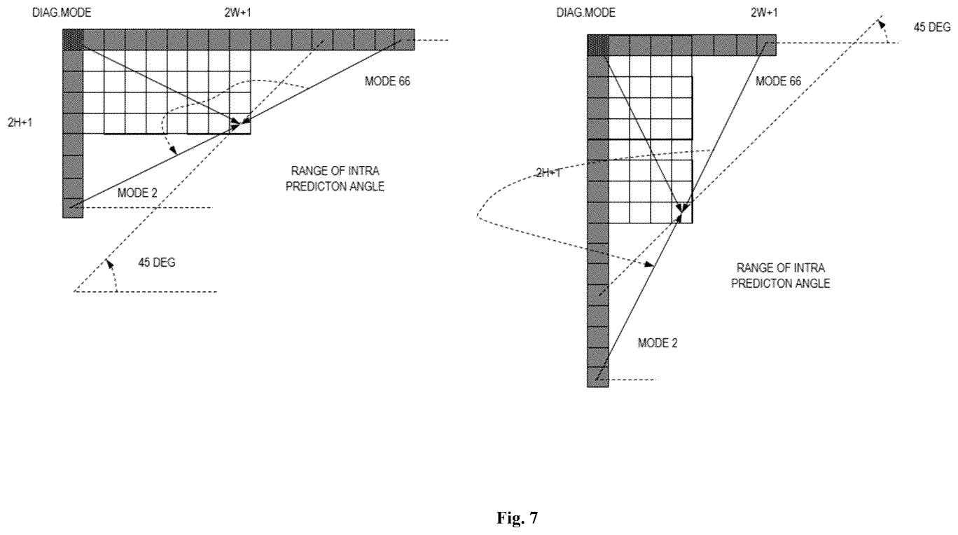

To support these prediction directions, the top reference with length 2W+1, and the left reference with length 2H+1, are defined as shown in FIG. 7.

The number of replaced modes in wide-angular direction mode depends on the aspect ratio of a block. The replaced intra prediction modes are illustrated in Table 2-2.

TABLE 2-2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

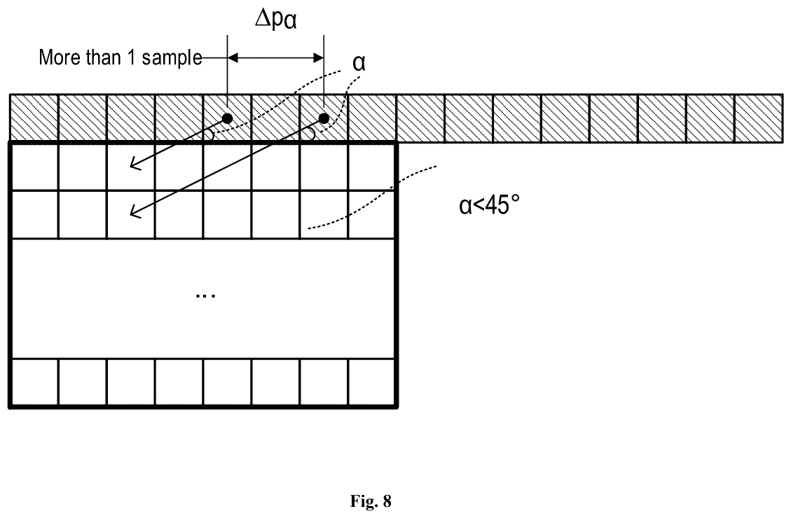

As shown in FIG. 8, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δpₓ. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.4. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

2.5. Intra Block Copy (IBC) Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.
   2.6. Merge Mode with MVD (MMVD)

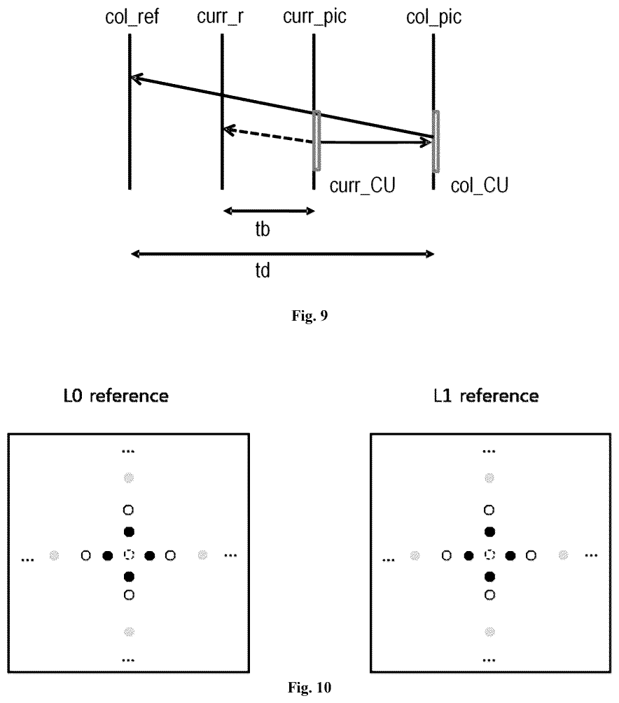

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU. In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates. FIG. 9 is an illustration of motion vector scaling for temporal merge candidate.

Distance index specifies motion magnitude information and indicate the pre-defined offset from the starting point. As shown in FIG. 10, an offset is added to either horizontal component or vertical component of starting MV. The relation of distance index and pre-defined offset is specified in Table 2-3.

TABLE 2-3
The relation of distance index and pre-defined offset

| | Distance IDX | | | | | | | |
|---|---|---|---|---|---|---|---|---|
| | 0 | 1 | 2 | 3 | 4 | 5 | 6 | 7 |
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2-4. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2-4 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 2-4 specifies the sign of MV offset added to the list0 MV component of starting MV and the sign for the list1 MV has opposite value. Otherwise, if the difference of POC in list 1 is greater than list 0, the sign in Table 2-4 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 9. If the POC difference of L1 is greater than L0, the MVD for list 0 is scaled in the same way. If the starting MV is uni-predicted, the MVD is added to the available MV.

TABLE 2-4
Sign of MV offset specified by direction index

Direction IDX

| | 00 | 01 | 10 | 11 |
|---|---|---|---|---|
| x-axis | + | − | N/A | N/A |
| y-axis | N/A | N/A | + | − |

### 2.7. Local Illumination Compensation (LIC)

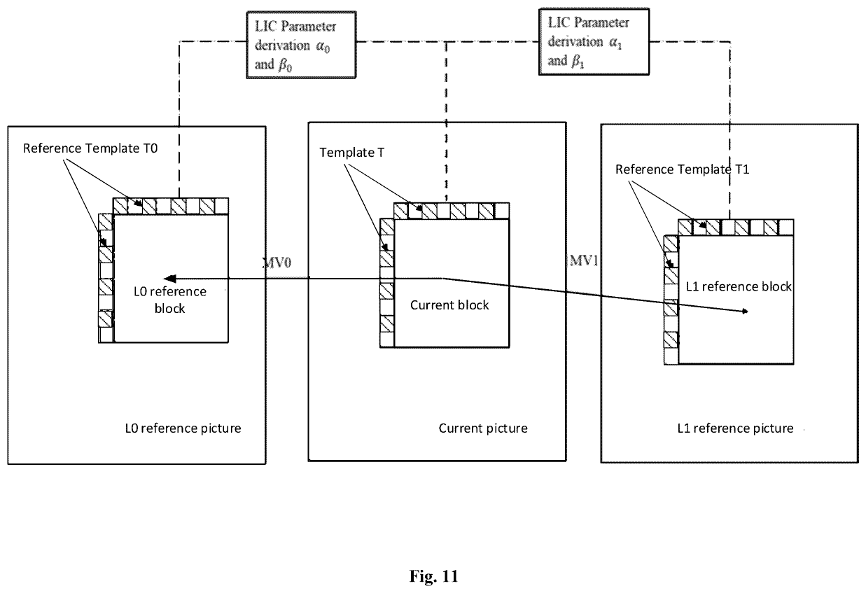

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x, y) is the prediction signal of the current block at the coordinate (x, y); Pᵣ(x+vₓ, y+v_{y}) is the reference block pointed by the motion vector (vₓ, v_{y}); α and β are the corresponding scaling factor and offset that are applied to the reference block. FIG. 11 illustrates the LIC process. In FIG. 11, when the LIC is applied for a block, a least mean square error (LMSE) method is employed to derive the values of the LIC parameters (i.e., α and β) by minimizing the difference between the neighboring samples of the current block (i.e., the template T in FIG. 11) and their corresponding reference samples in the temporal reference pictures (i.e., either TO or TI in FIG. 11). Additionally, to reduce the computational complexity, both the template samples and the reference template samples are subsampled (adaptive subsampling) to derive the LIC parameters, i.e., only the shaded samples in FIG. 11 are used to derive α and β.

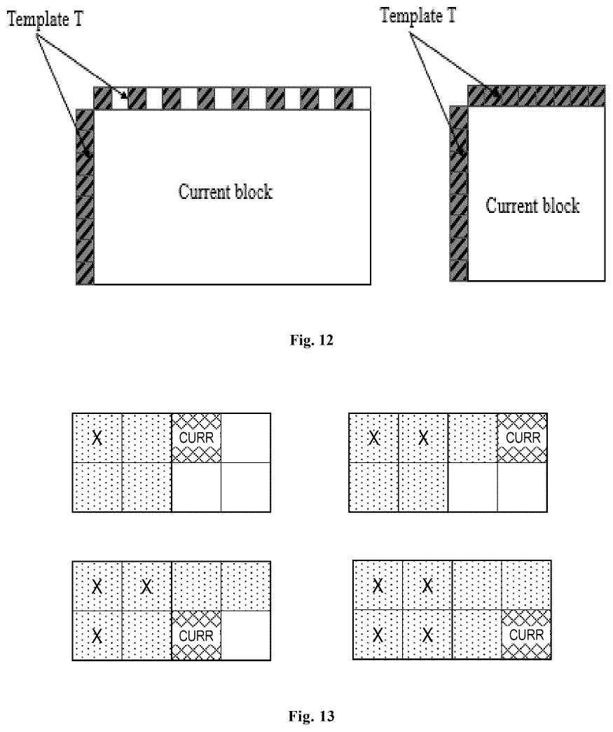

To improve the coding performance, no subsampling for the short side is performed as shown in FIG. 12.

2.8. IBC with Template Matching

It is proposed to also use Template Matching with IBC for both IBC merge mode and IBC AMVP mode.

The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained to be integer and within a reference region as shown in FIG. 13. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

2.9. IBC Merge Mode with Block Vector Differences

IBC merge mode with block vector differences is shown as follows.

The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### 2.10. Reconstruction-Reordered IBC (RR-IBC)

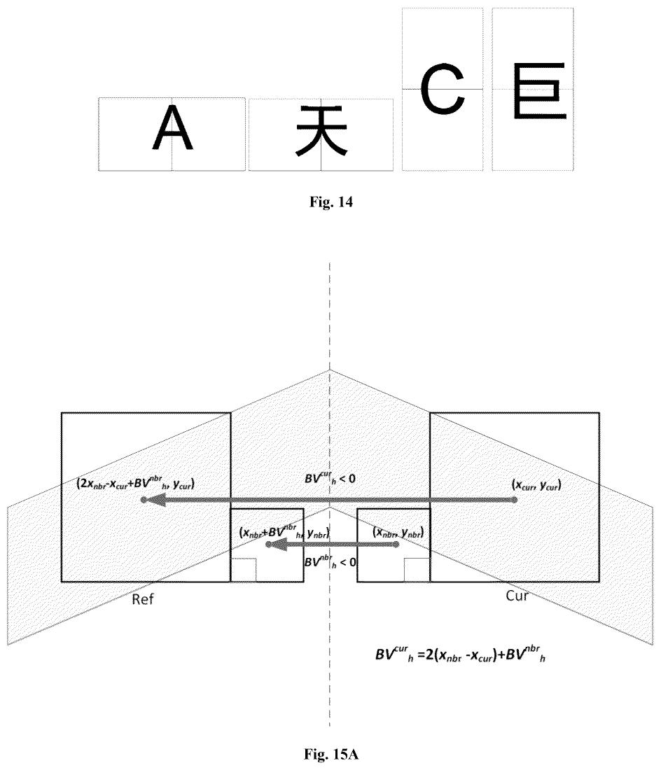

Screen content coding tools like Intra Block Copy (IBC) generate a prediction block by directly copying a prior coded reference region in the same picture. Symmetry is often observed in video content, especially in text character regions and computer-generated graphics in screen content sequences, as shown in FIG. 14. Therefore, a specific screen content coding tool considering the symmetry would be efficient to compress such kinds of video contents.

A Reconstruction-Reordered IBC (RR-IBC) mode is proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

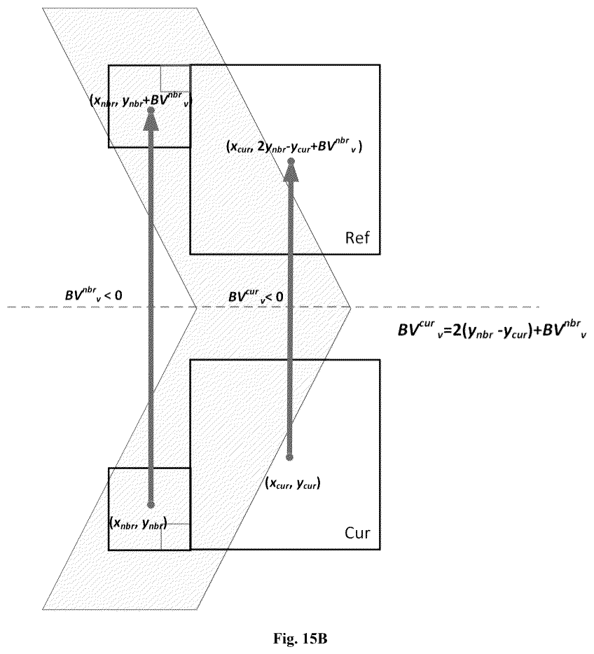

To better utilize the symmetry property, a flip-aware BV adjustment approach is applied to refine the block vector candidate. For example, as shown in FIGS. 15A and 15B, (x_{nbr}, y_{nbr}) and (x_{cur}, y_{cur}) represent the coordinates of the center sample of the neighboring block and the current block, respectively, BV^{nbr} and BV^{cur} denotes the BV of the neighboring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=²(y_{nbr}−y_{cur})+BV^{nbr}ᵥ.

### 2.11. Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

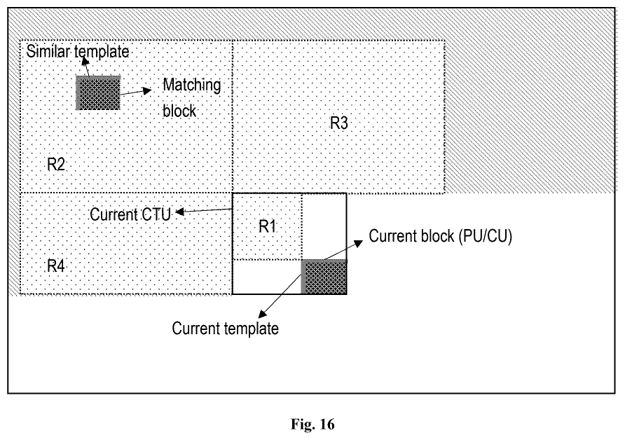

The prediction signal is generated by matching the L-shaped causal neighbor of the current block with another block in a predefined search area in FIG. 16 consisting of:
R1: current CTU
R2: top-left CTU
R3: above CTU
R4: left CTU.

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:
SearchRange_w=a*BlkW
SearchRange_h=a*BlkH
where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

2.12. Direct Block Vector (DBV) Mode for Chroma Prediction

In ECM-6.0, the intra prediction modes for chroma components include 6 cross component linear model (LM) modes, convolution cross component model (CCCM) mode, gradient linear model (GLM) mode, DIMD mode, direct mode (DM), and four default intra prediction modes.

In the signaling of chroma intra mode, an intra_chroma_pred_mode is signaled to indicate the specific coding mode, as shown in Table 2-5.

TABLE 2-5
The binarization process for
intra_chroma_pred_mode in ECM6.0

| intra_chroma_pred_mode | bin string | chroma intra mode |
|---|---|---|
| 0 | 1100 | list[0] |
| 1 | 1101 | list[1] |
| 2 | 1110 | list[2] |
| 3 | 1111 | list[3] |
| 4 | 10 | DIMD chroma |
| 5 | 0 | DM |

ECM6.0 includes a method of chroma prediction using block vector in MODE_IBC. In single tree partition, the prediction process of IBC is applied for both luma and chroma components, and the chroma block vector is derived from the corresponding luma block vector depending on the chroma format sampling structure. In dual tree partition, the prediction process of IBC is only applied for luma component.

This contribution proposes a method to improve the coding efficiency of chroma intra prediction for screen content, namely direct block vector (DBV) mode.

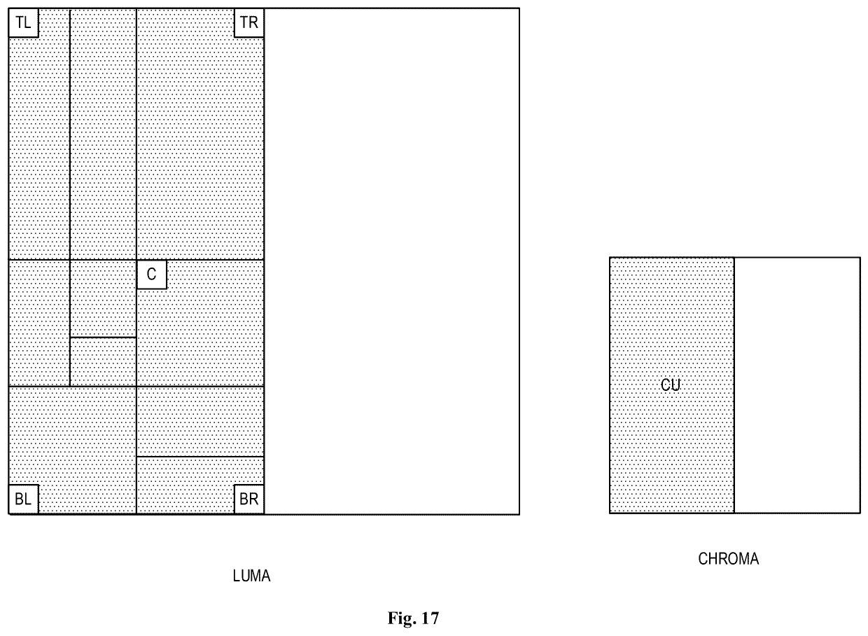

For chroma components, when chroma dual tree is activated in intra slice, if one of the luma blocks (the following five locations in FIG. 17) is coded with MODE_IBC, its block vector bvL is used and scaled to derive chroma block vector bvC. The scaling factor depends on the chroma format sampling structure.

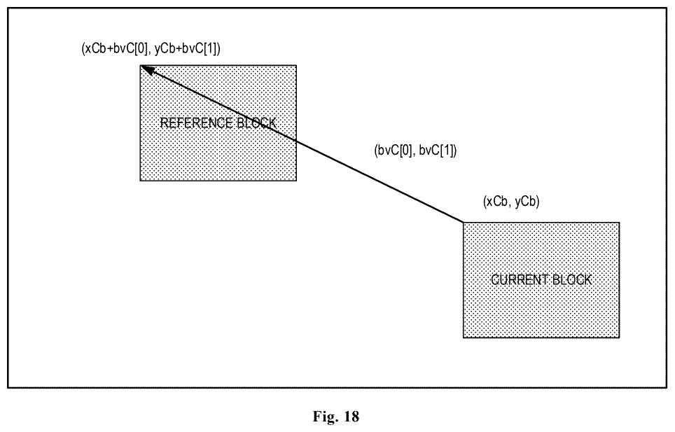

Then, by using the position of the current chroma block (xCb, yCb) and its bvC, the corresponding offset position (xCb+bvC[0], yCb+bvC[1]) is determined, and a block copying prediction is performed as shown in FIG. 18.

A CU level flag is signaled to indicate whether the proposed DBV mode is applied as shown in Table 2-6.

TABLE 2-6
The binarization process for
intra_chroma_pred_mode in the proposed method

| intra_chroma_pred_mode | bin string | chroma intra mode |
|---|---|---|
| 0 | 11100 | list[0] |
| 1 | 11101 | list[1] |
| 2 | 11110 | list[2] |
| 3 | 11111 | list[3] |
| 4 | 110 | DIMD chroma |
| 5 | 10 | DM |
| 6 | 0 | DBV |

### 2.13. Extensions of Intra Block Copy

Several coding tools combining inter prediction and intra prediction have been proposed to improve the coding performance of VTM and ECM, such as combined inter and intra prediction (CIIP), geometry partitioning mode with inter and intra prediction (GPM-intra). Similarly, intra block copy (IBC) could be improved by considering intra prediction.

Besides, LIC in ECM-6.0 is an inter prediction technique to model local illumination variation between current block and its prediction block. However, the illumination variation within a picture has not been studied.

In this contribution, three aspects are proposed to extend the use of IBC:
Aspect #1: Combined IBC and intra prediction (IBC-CIIP);
Aspect #2: IBC with geometry partitioning (IBC-GPM);
Aspect #3: IBC with local illumination compensation (IBC-LIC).

### 2.13.1. Combined IBC and Intra Prediction (IBC-CIIP)

When IBC-CIIP is applied to a CU, two prediction signals are obtained using IBC and intra prediction. The two prediction signals weighted summed to generate the final prediction. IBC-CIIP can be applied to IBC AMVP mode and IBC merge mode. A CU flag is signalled to indicate the use of IBC-CIIP.

2.13.2. IBC with Geometry Partitioning (IBC-GPM)

When IBC-GPM is applied to a CU, the CU is divided into two sub-partitions geometrically. The prediction signals of the two sub-partitions are generated using IBC and intra prediction. IBC-GPM can be applied to IBC merge mode. A CU flag is signalled to indicate the use of IBC-GPM.

2.13.3. IBC with Local Illumination Compensation (IBC-LIC)

When IBC-LIC is applied to a CU, local illumination variation between the CU and its prediction block is modelled as a linear equation. The parameters of the linear equation are derived similar to LIC for inter prediction. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

### 3. PROBLEMS

In current design of dual-tree partition in ECM, the prediction process of IBC is only applied for luma component. A method named direct block vector (DBV) mode is used in 2.12 to enable IBC for chroma components. However, only the first available luma block vector from five positions is scaled and used as the chroma block vector, which may limit the coding performance.

### 4. DETAILED SOLUTIONS

The detailed solutions below should be considered as examples to explain general concepts. These solutions should not be interpreted in a narrow way. Furthermore, these solutions can be combined in any manner.

In the present disclosure, intra block copy (IBC) may not be limited to the current IBC technology, but may be interpreted as the technology that reference (or prediction) block is obtained with samples in the current slice/tile/subpicture/picture/other video unit (e.g., CTU row) excluding the conventional intra prediction methods. In the following discussion, IBC may be replaced by other coding tools that rely on coded/decoded/reconstructed information within the same region, e.g., palette, intra template matching.

### Determination of Block Vector for Chroma Prediction

1. It is proposed that at least one block vector (BV) candidate list is constructed for a video unit, and one or more block vectors in the list may be used for chroma prediction of the video unit.
   a. In one example, the list(s) may be constructed in different ways for single tree and dual tree structure.
      i. In one example, different lists may be constructed for luma and chroma components if dual tree structure is applied.
      ii. In one example, the list(s) may be shared by luma and chroma components if single tree structure is applied.
   b. In one example, different chroma components (such as Cb and Cr) may share the same BV.
   c. In one example, different chroma components (such as Cb and Cr) may have different BVs.
      i. For example, the BVs for the two components may be refined separately.
         1) The refinement may be template matching.
   d. In one example, one or more BVs of the list used for chroma component(s) may be derived from luma component.
      i. In one example, the BV of the collocated luma video unit may be used.
         1) In one example, the collocated luma video is located by a luma position (P_{L} (x, y)), wherein the luma position is obtained by a chroma position (P_{C} (x, y)) and the subsampling ratio for luma and chroma in different colour formats.
         a) In one example, P_{L}(x, y)=P_{C}(x*SubWidthC, y*SubHeightC).
         2) In one example, (P_{C}(x, y)) may refer to the center position of the chroma video unit. Denote the width and height of the chroma video unit as W and H, and x is in the range of 0 and W−1, inclusive, and y is in the range of 0 and H−1, inclusive.
         a) In one example, (P_{C}(x, y))=(W/2−1, H/2+1).
         b) In one example, (P_{C}(x, y))=(W/2+1, H/2−1).
         c) In one example, (P_{C}(x, y))=(W/2−1, H/2+1).
         d) In one example, (P_{C}(x, y))=(W/2+1, H/2+1).
         3) In one example, (P_{C}(x, y)) may refer to the left-top/right-top/left-bottom/right-bottom position of the chroma video unit.
      ii. In one example, one or more BVs of the spatial neighboring video units of the collocated luma video unit (adjacent and/or non-adjacent) may be used.
      iii. In one example, one or more BVs in the history based block vector prediction (HBVP) table for IBC of luma component may be used.
         1) For example, BV for a previously coded block may be inserted to the HBVP table.
      iv. In one example, when the neighboring video units of the collocated luma video unit are coded using a certain mode, one or more derived BVs from the neighboring video units may be used.
         1) For example, the certain mode may be Intra TMP.
         2) For example, the certain mode may be IBC.
      v. In one example, the BVs derived from luma component may be scaled before being used to construct the BV candidate list for chroma component.
         1) In one example, whether to and/or how to scale the BVs may depending on the colour format. Denote bvLx, bvLy, bvCx, bvCy as the two components of a luma BV and the two components of a scaled chroma BV.
         a) In one example, bvCx=bvLx>>(SubWidthC−1).
         b) In one example, bvCy=bvLy>>(SubHeightC−1).
   e. In one example, one or more BVs in the list may be derived from chroma component.
      i. In one example, one or more BVs of the spatial neighboring video units of the current video unit (adjacent and/or non-adjacent) may be used.
      ii. In one example, a HBVP table may be constructed for chroma component.
         1) In one example, how to generate/update/fill/define the HBVP table for chroma may be same as luma.
         a) Alternatively, how to generate/update/fill/define the HBVP table for chroma may be different from luma.
         2) In one example, how to use the HBVP table for chroma may be same as luma.
         a) Alternatively, how to use the HBVP table for chroma may be different from luma.
         3) In one example, one or more BVs in the HBVP table for chroma may be used.
      iii. In one example, when the neighboring video units are coded using a certain mode, one or more derived BVs from the neighboring video units may be used.
         1) For example, the certain mode may be Intra TMP.
         2) For example, the certain mode may be IBC.
   f. In one example, one or more default BVs may be used.
   g. In one example, the one or more BVs may be added to the BV candidate list with different priorities.
      i. In one example, the BVs from the collocated luma videos may be added first.
      ii. In one example, the BVs from a first candidate type may be added before the BVs from a second candidate type, and the first candidate type is different from the second candidate type.
         1) In one example, the first/second candidate type may refer to adjacent spatial neighboring video units, or non-adjacent spatial neighboring video units, or HBVP, or video units coded by Intra TMP.
      iii. In one example, the default BVs may be added to the last positions of the BV candidate list.
   h. In one example, the BV candidate list may be reordered.
      i. In one example, template matching (TM) or bilateral matching (BM) cost may be used for the reordering.
      ii. In one example, the BV candidate list may be divided into different subgroups, and the reordering may be applied within the subgroup.
      iii. In one example, a BV index in the reordered list may be signalled in the bitstream.
      iv. In one example, the BV within minimum TM/BM cost (e.g., at the first order in the reordered list) may be implicitly used to the video unit without signalling.
   i. In one example, the BVs in the list may be refined.
      i. In one example, TM may be used to refine the BV.
      ii. In one example, BM may be used to refine the BV.
   j. In one example, an index may be signalled in the bitstream to indicate which BV in the BV candidate list is used for chroma prediction.
      i. Alternatively, the index may be derived instead of being signalled.
   k. In one example, the first available BV in the BV candidate list may be used for chroma prediction.
   l. In one example, a BV candidate may be constructed by using at least one BV derived from luma component and at least one BV derived from chroma component.
      i. For example, a BV candidate may be constructed by averaging one BV derived from luma component and one BV derived from chroma component.
2. It is proposed that a BV offset may be added to the BV used for chroma prediction.
   a. In one example, the offset or index(s) indicating the offset in an offset set may be signalled in the bitstream or derived.
      i. In one example, the offset set may pre-defined or signalled in the bitstream.
      ii. In one example, the offset set may be reordered. In one example, the combinations of BVs in the candidate list and BV offsets in the offset set may be reordered.
      iii. In one example, the offset set may be defined as a distance table and a direction table (e.g., an example is shown in Table 2-3 and Table 2-4).
         1) In one example, a first index in distance table and a second index in the direction table may be coded separately.
      iv. In one example, the offset set may be defined as a single table (e.g., containing both distance and direction information).
         1) In one example, one index in the offset set may be coded.
      v. In one example, the index may be context coded.
      vi. In one example, the index in the reordered list may be coded with rice parameter.
      vii. In one example, the offset set may depend on coding information.
      viii. In one example, the offset may be derived using TM or BM based method.
         1) In one example, the offset may be shared by different colour components.
         2) In one example, the offset may be different for different colour components.
   b. In one example, whether to add the BV offset may be signalled in the bitstream.
      i. In one example, a syntax element may be signalled to indicate whether a BV offset is used.
      ii. In one example, one or more syntax elements may be signalled to indicate the BV offset.
         1) In one example, the BV offset may be equal to zero.
         2) In one example, reordering may be used to signal or derive the BV offset.
   c. In one example, the offset of one component (such as Cb or Cr) may be predicted by the offset of another component (such as Y).
3. In one example, the chroma prediction derived using the BV may be fused with other coding method.
   a. In on example, the other coding method may refer to traditional intra prediction mode, or CCLM, or MMLM, or CCCM, or GLM, or DIMD, or TIMD, or Intra TMP.
   b. In one example, the chroma prediction derived using the BV may be fused with inter prediction modes (e.g., CIIP (e.g., CIIP-Planar, CIIP-TIMD, CIIP-TM), BCW (e.g., BCW index derived by TM), MMVD (e.g., MMVD or TM based reordering for MMVD), template matching (TM), IBC (e.g., IBC-TM, IBC with block vector differences, IBC with reconstruction reordering), affine (e.g., affine-MMVD, TM based reordering for affine MMVD), DMVR/multi-pass DMVR, PROF, BDOF/sample based BDOF, adaptive decoder-side motion vector refinement (ADMVR), OBMC or TM based OBMC, MHP, GPM (e.g., GPM, GPM-TM, GPM-MMVD, GPM-intra), bilateral/template matching AMVP-merge mode).
   c. In one example, the chroma prediction derived using the BV may be fused with luma prediction/reconstruction.
   d. In one example, the weights used for fusion may be pre-defined, or signalled in the bitstream, or derived depending on coding information.
   e. In on example, whether to and/or how to fuse the chroma prediction may be signalled.
      i. Alternatively, whether to and/or how to fuse the chroma prediction may depend on coding information.
         1) In one example, it may depend on whether fusion is used for the collocated luma video unit.
         2) In one example, it may depend on the sequence content, such as the fusion is not used for SCC sequences.
      ii. In one example, a high level syntax (HLS) may be signalled to indicate whether the fusion can be used.
   f. In on example, whether to and/or how to fuse the chroma prediction may be derived.
      i. In one example, TM based method may be used.
4. In one example, the chroma BV of the current video unit may be used for the following video units.
   a. In one example, the chroma BV of the current video unit may be stored.
   b. In one example, the chroma BV of the current video unit may be added in the HBVP table for chroma.
   c. In one example, the chroma BV of the current video unit may be used for the current block's processing (e.g., transform, MTS, LFNST, deblocking, loop filtering, etc.).
   d. Alternatively, the chroma BV of the current video unit may be not used for the following video units.
5. In one example, when IBC is used for chroma prediction, a specific coding tool may be allowed to be used.
   a. In one example, the specific coding tool may refer to IBC-TM, IBC-MBVD, RR-IBC, or IBC-IBC, or IBC-GPM, or IBC-CIIP.
      i. In one example, a syntax element may be signalled in the bitstream to indicate whether the specific coding tool is used for chroma prediction.
   b. In one example, the flip type of chroma RR-IBC may be inherited from the flip type of a luma block.
      i. For example, the luma block may be a collocated luma block, and/or its spatial (adjacent/non-adjacent) neighboring blocks, and/or a luma block which has a different position rather than the collocated one.
      ii. Alternatively, the flip type of chroma RR-IBC block may be independently determined (e.g., the flip type of the chroma block may be different from the luma block).
   c. Alternatively, the specific coding tool may be disallowed to be used.
   d. In one example, it is used in dual tree.
   e. In one example, it is used in single tree.

### General Aspects

6. In above examples, the video unit may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block(PB)/transform block (TB)/a block/sub-block of a block/sub-region within a block/any other region that contains more than one sample or pixel.
7. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
8. Whether to and/or how to apply the disclosed methods above may be signalled at PB/TB/CB/PU/TU/CU/VPDU/CTU/CTU row/slice/tile/sub-picture/other kinds of region contains more than one sample or pixel.
9. Whether to and/or how to apply the disclosed methods above may be dependent on coded information, such as block size, colour format, single/dual tree partitioning, colour component, slice/picture type.

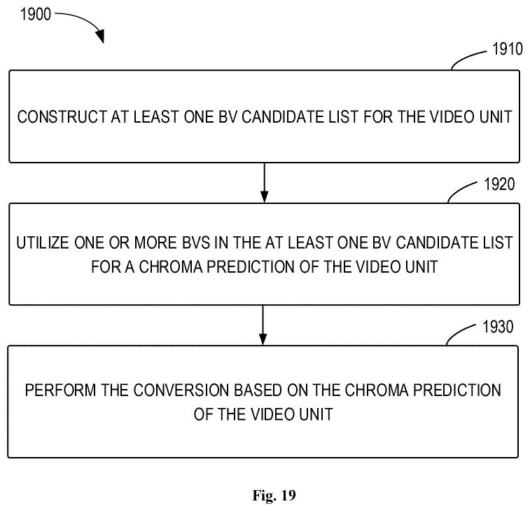

FIG. 19 illustrates a flowchart of a method 1900 for video processing in accordance with embodiments of the present disclosure. The method 1900 is implemented during a conversion between a target video block of a video and a bitstream of the video.

At block 2010, for a conversion between a video unit of a video and a bitstream of the video, at least one block vector (BV) candidate list for the video unit is constructed.

At block 2020, one or more BVs in the at least one BV candidate list are utilized for a chroma prediction of the video unit. In some embodiments, one or more default BVs in the at least one BV candidate list are used for the chroma prediction of the video unit.

At block 2030, the conversion is performed based on the chroma prediction of the video unit. In some embodiments, the conversion may include encoding the video unit into the bitstream. Alternatively, the conversion may include decoding the video unit from the bitstream. In this way, it can improve coding efficiency and coding performance.

In some embodiments, different chroma components may share a same BV in the at least one BV candidate list. For example, the different chroma components comprise Cb and Cr components.

In some embodiments, one or more BVs in the at least one BV candidate list are derived from a chroma component. In some embodiments, one or more BVs of spatial neighboring video units of the video unit are used for the chroma prediction of the video unit. For example, the spatial neighboring video units may be adjacent and/or non-adjacent.

In some embodiments, a history based block vector prediction (HBVP) table is constructed for chroma component. In some embodiments, an approach for generating (updating/filling/defining) the HBVP table for chroma component is same as an approach for generating the HBVP table for luma component. Alternatively, the approach for generating the HBVP table for chroma component is different from the approach for generating the HBVP table for luma component.

In some embodiments, an approach for using the HBVP table for chroma component is same as an approach for using the HBVP table for luma component. Alternatively, the approach for using the HBVP table for chroma component is different from the approach for using the HBVP table for luma component.

In some embodiments, one or more BVs in the HBVP table for chroma are used for the chroma prediction. In some embodiments, when neighboring video units are coded using a target mode, one or more derived BVs from the neighboring video units are used for the chroma prediction. In some embodiments, the target mode is one of: intra template matching (Intra TMP) mode, or an intra block copy (IBC) mode.

In some embodiments, one or more BVs of the at least one BV candidate list used for chroma component are derived from luma component. In some embodiments, a BV of a collocated luma video unit is used. In some embodiments, the collocated luma video is located by a luma position (P_{L}(x, y)). The luma position may be obtained by a chroma position (P_{C}(x, y)) and a subsampling ratio for luma and chroma in different colour formats. In some embodiments, P_{L}(x, y)=P_{C}(x*SubWidthC, y*SubHeightC).

In some embodiments, the chroma position (P_{C}(x, y)) is a center position of a chroma video unit. In some embodiments, (P_{C}(x, y))=(W/2−1, H/2+1), or (P_{C}(x, y))=(W/2+1, H/2−1), or (P_{C} (x, y))=(W/2−1, H/2+1), or (P_{C}(x, y))=(W/2+1, H/2+1). W may represent a width of the chroma video unit, H may represent a height of the chroma video unit, x may be in the range of 0 and W−1, and y may be in the range of 0 and H−1. In some other embodiments, the chroma position (P_{C}(x, y)) is one of a left-top position of the chroma video unit, a right-top position of the chroma video unit, a left-bottom position of the chroma video unit, or a right-bottom position of the chroma video unit.

In some embodiments, one or more BVs of spatial neighboring video units of a collocated luma video unit are used for the chroma prediction. In one example, one or more BVs of the spatial neighboring video units of the collocated luma video unit (adjacent and/or non-adjacent) may be used.

In some embodiments, one or more BVs in a HBVP table for IBC of luma component are used for the chroma prediction. In some embodiments, a BV for a previously coded block is inserted to the HBVP table.

In some embodiments, when neighboring video units of a collocated luma video unit are coded using a target mode, one or more derived BVs from the neighboring video units are used for the chroma prediction. In some embodiments, the target mode is one of: an Intra TMP, or an IBC mode. In some embodiments, one or more BVs derived from luma component are scaled before being used to construct the at least one BV candidate list.

In some embodiments, whether to and/or how to scale the one or more BVs is dependent on a colour format. In some embodiments, bvCx=bvLx>>(SubWidthC−1), or wherein bvCy=bvLy>>(SubHeightC−1), and where bvLx and bvLy represent two components of a luma BV, and bvCx and bvCy represent two components of a scaled chroma BV.

In some embodiments, the one or more BVs are added to the at least one BV candidate list with different priorities. In some embodiments, BVs from collocated luma videos are added first.

In some embodiments, BVs from a first candidate type are added before BVs from a second candidate type, and wherein the first candidate type is different from the second candidate type. In some embodiments, the first candidate type or the second candidate type is one of: adjacent spatial neighboring video units, non-adjacent spatial neighboring video units, a HBVP, or video units coded by Intra TMP. In some embodiments, default BVs are added to last positions of the at least one BV candidate list.

In some embodiments, the at least one BV candidate list is reordered. In some embodiments, template matching (TM) or bilateral matching (BM) cost is used for reordering the at least one BV candidate list. In some embodiments, the at least one BV candidate list is divided into different subgroups, and the reordering of the at least one BV candidate list is applied within a subgroup. In some embodiments, a BV index in the reordered BV candidate list is indicated in the bitstream. In some embodiments, a BV within minimum TM or BM cost (e.g., at the first order in the reordered list) is implicitly used to the video unit without signalling.

In some embodiments, the at least one BV candidate list is constructed in different ways for single tree and dual tree structure. In some embodiments, different BV candidate lists are constructed for luma and chroma components if dual tree structure is applied. In some embodiments, the at least one BV candidate list is shared by luma and chroma components if single tree structure is applied.

In some embodiments, different chroma components have different BVs. For example, BVs for two components are refined separately. In some embodiments, the refinement of the BVs is template matching.

In some embodiments, BVs in the at least one BV candidate list are refined. In some embodiments, TM is used to refine the BVs. Alternatively, BM is used to refine the BVs.

In some embodiments, an index is indicated in the bitstream to indicate which BV in the at least one BV candidate list is used for chroma prediction. In some embodiments, an index is indicated in the bitstream to indicate which BV in the at least one BV candidate list is derived.

In some embodiments, a first available BV in the at least one BV candidate list is used for the chroma prediction. In some embodiments, a BV candidate is constructed by using at least one BV derived from luma component and at least one BV derived from chroma component. In some embodiments, a BV candidate is constructed by averaging one BV derived from luma component and one BV derived from chroma component.

In some embodiments, a BV offset is added to the one or more BVs used for the chroma prediction. In some embodiments, the BV offset or an index indicating the BV offset in an offset set is indicated in the bitstream. Alternatively, the BV offset or the index indicating the BV offset in the offset set is derived.

In some embodiments, the BV offset set is pre-defined. Alternatively, the BV offset is indicated in the bitstream. In some embodiments, the BV offset set is reordered. In some embodiments, combinations of BVs in the at least one BV candidate list and BV offsets in the offset set are reordered.

In some embodiments, the offset set is defined as a distance table and a direction table (for example, an example is shown in Table 2-3 and Table 2-4). In some embodiments, a first index in the distance table and a second index in the direction table are coded separately.

In some embodiments, the offset set is defined as a single table. For example, the single table may include both distance and direction information. In some embodiments, the index indicating the BV offset in the offset set is coded.

In some embodiments, the index indicating the BV offset is context coded. In some embodiments, the index indicating the BV offset in a reordered BV candidate list is coded with rice parameter. In some embodiments, the offset set depends on coding information.

In some embodiments, the BV offset is derived using a TM or BM based approach. In some embodiments, the BV offset is shared by different colour components. Alternatively, the BV offset is different for different colour components.

In some embodiments, whether to add the BV offset is indicated in the bitstream. In some embodiments, a syntax element is signalled to indicate whether the BV offset is used.

In some embodiments, one or more syntax elements are signalled to indicate the BV offset. In some embodiments, the BV offset is equal to zero. In some embodiments, a reordering is used to signal or derive the BV offset. In some embodiments, a BV offset of one component (such as Cb or Cr) is predicted by an BV offset of another component (Such as Y).

In some embodiments, the chroma prediction derived using the one or more BVs is combined with other coding method. In some embodiments, the other coding method may include one or more of: a traditional intra prediction mode, a cross-component linear mode (CCLM), a multi-mode learner mode (MMLM), a convolutional cross-component model (CCCM), a general linear mode (GLM), a decoder-side intra mode derivation (DIMD), a template-based intra mode derivation (TIMD), or an Intra TMP.

In some embodiments, the chroma prediction derived using the one or more BVs is combined with at least one of: an inter prediction mode (e.g., CIIP, CIIP-Planar, CIIP-TIMD, CIIP-TM), a bi-prediction with coding unit-level weight (BCW) (e.g., BCW index derived by TM), a merge mode with motion vector difference (MMVD) (e.g., MMVD or TM based reordering for MMVD), a template matching (TM), an IBC (e.g., IBC-TM, IBC with block vector differences, IBC with reconstruction reordering), an affine (e.g., affine-MMVD, TM based reordering for affine MMVD), a decoder side motion vector refinement (DMVR), a multi-pass DMVR, a prediction refinement with optical flow (PROF), a bi-directional optical flow (BDOF), a sampled based BDOF, adaptive decoder-side motion vector refinement (ADMVR), an overlapped block motion compensation (OBMC), a TM based OBMC, a multi-hypothesis prediction (MHP), a geometric partition mode (GPM) (e.g., GPM, GPM-TM, GPM-MMVD, GPM-intra), a bilateral AMVP-merge mode, or a template matching AMVP-merge mode. In some embodiments, the chroma prediction derived using the one or more BVs is combined with luma prediction or luma reconstruction.

In some embodiments, weights used for the combination are pre-defined. Alternatively, the weights are indicated in the bitstream. In some other embodiments, the weights are derived depending on coding information.

In some embodiments, whether to and/or an approach to combine the chroma prediction is indicated. In some embodiments, whether to and/or an approach to combine the chroma prediction depends on coding information. In some embodiments, whether to and/or an approach to combine the chroma prediction depends on whether combination is used for the collocated luma video unit. In some embodiments, whether to and/or an approach to combine the chroma prediction depends on a sequence content, such as the fusion is not used for SCC sequences.

In some embodiments, a high-level syntax (HLS) is signalled to indicate whether the combination is used. In some embodiments, whether to and/or an approach to combine the chroma prediction is derived. In some embodiments, TM based method is used in combining the chroma prediction.

In some embodiments, a chroma BV of the video unit is used for following video units. In some embodiments, the chroma BV of the video unit is stored. In some embodiments, the chroma BV of current video unit is added in the HBVP table for chroma. In some embodiments, the chroma BV of the video unit is used for a current block's processing (e.g., transform, MTS, LFNST, deblocking, loop filtering, etc.). In some embodiments, the chroma BV of the video unit is not used for the following video units.

In some embodiments, when IBC is used for the chroma prediction, a target coding tool is allowed to be used. For example, the target coding tool comprises at least one of: an IBC-TM, an IBC merge mode with block vector differences (IBC-MBVD), a reconstruction-reordered IBC (RR-IBC), an IBC-IBC, an IBC-GPM, or an IBC-combined inter and intra prediction (IBC-CIIP). In some embodiments, a syntax element is signalled in the bitstream to indicate whether the target coding tool is used for chroma prediction.

In some embodiments, a flip type of chroma RR-IBC block is inherited from a flip type of a luma block. For example, the luma block is at least one of: a collocated luma block, spatial (adjacent/non-adjacent) neighboring blocks of the collocated luma block, or a luma block which has a different position rather than the collocated one.

In some embodiments, a flip type of chroma RR-IBC block is independently determined. For example, the flip type of the chroma block may be different from the luma block.

In some embodiments, the target coding tool is used in dual tree, or wherein the target coding tool is used in single tree. In some embodiments, when IBC is used for the chroma prediction, a target coding tool is disallowed to be used. In some embodiments, the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

In some embodiments, an indication of whether to and/or how to utilize the one or more BVs in the at least one BV candidate list for the chroma prediction of the video unit is indicated at one of the followings: sequence level, group of pictures level, picture level, slice level, or tile group level.

In some embodiments, an indication of whether to and/or how to utilize the one or more BVs in the at least one BV candidate list for the chroma prediction of the video unit is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to utilize the one or more BVs in the at least one BV candidate list for the chroma prediction of the video unit is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 1900 further comprises: determining, based on coded information of the video unit, whether and/or how to utilize the one or more BVs in the at least one BV candidate list for the chroma prediction of the video unit, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: constructing at least one block vector (BV) candidate list for a video unit of the video; utilizing one or more BVs in the at least one BV candidate list for a chroma prediction of the video unit; and generating the bitstream based on the chroma prediction of the video unit.

According to still further embodiments of the present disclosure, a method for storing bitstream of a video is provided. The method comprises: constructing at least one block vector (BV) candidate list for a video unit of the video; utilizing one or more BVs in the at least one BV candidate list for a chroma prediction of the video unit; generating the bitstream based on the chroma prediction of the video unit; and storing the bitstream in a non-transitory computer-readable medium.

Implementations of the present disclosure can be described in view of the following clauses, the features of which can be combined in any reasonable manner.

Clause 1. A method of video processing, comprising: constructing, for a conversion between a video unit of a video and a bitstream of the video, at least one block vector (BV) candidate list for the video unit; utilizing one or more BVs in the at least one BV candidate list for a chroma prediction of the video unit; and performing the conversion based on the chroma prediction of the video unit.

Clause 2. The method of clause 1, wherein different chroma components share a same BV in the at least one BV candidate list.

Clause 3. The method of clause 2, wherein the different chroma components comprise Cb and Cr components.

Clause 4. The method of clause 1, wherein one or more default BVs in the at least one BV candidate list are used for the chroma prediction of the video unit.

Clause 5. The method of clause 1, wherein one or more BVs in the at least one BV candidate list are derived from a chroma component.

Clause 6. The method of clause 5, wherein one or more BVs of spatial neighboring video units of the video unit are used for the chroma prediction of the video unit.

Clause 7. The method of clause 5, wherein a history based block vector prediction (HBVP) table is constructed for chroma component.

Clause 8. The method of clause 7, wherein an approach for generating the HBVP table for chroma component is same as an approach for generating the HBVP table for luma component, or wherein the approach for generating the HBVP table for chroma component is different from the approach for generating the HBVP table for luma component.

Clause 9. The method of clause 7, wherein an approach for using the HBVP table for chroma component is same as an approach for using the HBVP table for luma component, or wherein the approach for using the HBVP table for chroma component is different from the approach for using the HBVP table for luma component.

Clause 10. The method of clause 7, wherein one or more BVs in the HBVP table for chroma component are used for the chroma prediction.

Clause 11. The method of clause 5, wherein when neighboring video units are coded using a target mode, one or more derived BVs from the neighboring video units are used for the chroma prediction.

Clause 12. The method of clause 11, wherein the target mode is one of: intra template matching (Intra TMP) mode, or an intra block copy (IBC) mode.

Clause 13. The method of clause 1, wherein one or more BVs of the at least one BV candidate list used for chroma component are derived from luma component.

Clause 14. The method of clause 13, wherein a BV of a collocated luma video unit is used.

Clause 15. The method of clause 14, wherein the collocated luma video unit is located by a luma position (PL(x, y)), wherein the luma position is obtained by a chroma position (PC(x, y)) and a subsampling ratio for luma and chroma in different colour formats.

Clause 16. The method of clause 15, wherein PL(x, y)=PC(x*SubWidthC, y*SubHeightC), wherein SubWidthC and SubHeightC are variables.

Clause 17. The method of clause 15, wherein the chroma position (PC(x, y)) is a center position of a chroma video unit.

Clause 18. The method of clause 17, wherein (PC(x, y))=(W/2−1, H/2+1), or wherein (PC(x, y))=(W/2+1, H/2−1), or wherein (PC(x, y))=(W/2−1, H/2+1), or wherein (PC(x, y))=(W/2+1, H/2+1), and wherein W represents a width of the chroma video unit, H represents a height of the chroma video unit, x is in the range of 0 and W−1, and y is in the range of 0 and H−1.

Clause 19. The method of clause 15, wherein the chroma position (PC(x, y)) is one of a left-top position of a chroma video unit, a right-top position of the chroma video unit, a left-bottom position of the chroma video unit, or a right-bottom position of the chroma video unit.

Clause 20. The method of clause 13, wherein one or more BVs of spatial neighboring video units of a collocated luma video unit are used for the chroma prediction.

Clause 21. The method of clause 13, wherein one or more BVs in a HBVP table for IBC of luma component are used for the chroma prediction.

Clause 22. The method of clause 21, wherein a BV for a previously coded block is inserted to the HBVP table.

Clause 23. The method of clause 13, wherein when neighboring video units of a collocated luma video unit are coded using a target mode, one or more derived BVs from the neighboring video units are used for the chroma prediction.

Clause 24. The method of clause 23, wherein the target mode is one of: an Intra TMP, or an IBC mode.

Clause 25. The method of clause 13, wherein one or more BVs derived from luma component are scaled before being used to construct the at least one BV candidate list.

Clause 26. The method of clause 25, wherein whether to and/or how to scale the one or more BVs is dependent on a colour format.

Clause 27. The method of clause 26, wherein bvCx=bvLx>>(SubWidthC−1), or wherein bvCy=bvLy>>(SubHeightC−1), and wherein bvLx and bvLy represent two components of a luma BV, and bvCx and bvCy represent two components of a scaled chroma BV.

Clause 28. The method of clause 1, wherein the one or more BVs are added to the at least one BV candidate list with different priorities.

Clause 29. The method of clause 28, wherein BVs from collocated luma video unit are added first.

Clause 30. The method of clause 28, wherein BVs from a first candidate type are added before BVs from a second candidate type, and wherein the first candidate type is different from the second candidate type.

Clause 31. The method of clause 30, wherein the first candidate type or the second candidate type is one of: adjacent spatial neighboring video units, non-adjacent spatial neighboring video units, a HBVP, or video units coded by Intra TMP.

Clause 32. The method of clause 28, wherein default BVs are added to last positions of the at least one BV candidate list.

Clause 33. The method of clause 1, wherein the at least one BV candidate list is reordered.

Clause 34. The method of clause 33, wherein template matching (TM) or bilateral matching (BM) cost is used for reordering the at least one BV candidate list.

Clause 35. The method of clause 33, wherein the at least one BV candidate list is divided into different subgroups, and the reordering of the at least one BV candidate list is applied within a subgroup.

Clause 36. The method of clause 33, wherein a BV index in the reordered BV candidate list is indicated in the bitstream.

Clause 37. The method of clause 33, wherein a BV within minimum TM or BM cost is implicitly used to the video unit without signalling.

Clause 38. The method of clause 1, wherein the at least one BV candidate list is constructed in different ways for single tree and dual tree structure.

Clause 39. The method of clause 38, wherein different BV candidate lists are constructed for luma and chroma components if dual tree structure is applied.

Clause 40. The method of clause 38, wherein the at least one BV candidate list is shared by luma and chroma components if single tree structure is applied.

Clause 41. The method of clause 1, wherein different chroma components have different BVs.

Clause 42. The method of clause 41, wherein BVs for two components are refined separately.

Clause 43. The method of clause 42, wherein the refinement of the BVs is template matching.

Clause 44. The method of clause 1, wherein BVs in the at least one BV candidate list are refined.

Clause 45. The method of clause 44, wherein TM is used to refine the BVs, or wherein BM is used to refine the BVs.

Clause 46. The method of clause 1, wherein an index is indicated in the bitstream to indicate which BV in the at least one BV candidate list is used for chroma prediction.

Clause 47. The method of clause 1, wherein an index is indicated in the bitstream to indicate which BV in the at least one BV candidate list is derived.

Clause 48. The method of clause 1, wherein a first available BV in the at least one BV candidate list is used for the chroma prediction.

Clause 49. The method of clause 1, wherein a BV candidate is constructed by using at least one BV derived from luma component and at least one BV derived from chroma component.

Clause 50. The method of clause 1, wherein a BV candidate is constructed by averaging one BV derived from luma component and one BV derived from chroma component.

Clause 51. The method of any of clauses 1-50, wherein a BV offset is added to the one or more BVs used for the chroma prediction.

Clause 52. The method of clause 51, wherein the BV offset or an index indicating the BV offset in an offset set is indicated in the bitstream, or wherein the BV offset or the index indicating the BV offset in the offset set is derived.

Clause 53. The method of clause 52, wherein the BV offset set is pre-defined or wherein the BV offset is indicated in the bitstream.

Clause 54. The method of clause 52, wherein the BV offset set is reordered.

Clause 55. The method of clause 52, wherein combinations of BVs in the at least one BV candidate list and BV offsets in the offset set are reordered.

Clause 56. The method of clause 52, wherein the offset set is defined as a distance table and a direction table.

Clause 57. The method of clause 56, wherein a first index in the distance table and a second index in the direction table are coded separately.

Clause 58. The method of clause 52, wherein the offset set is defined as a single table.

Clause 59. The method of clause 58, wherein the index indicating the BV offset in the offset set is coded.

Clause 60. The method of clause 52, wherein the index indicating the BV offset is context coded.

Clause 61. The method of clause 52, wherein the index indicating the BV offset in a reordered BV candidate list is coded with rice parameter.

Clause 62. The method of clause 52, wherein the offset set depends on coding information.

Clause 63. The method of clause 52, wherein the BV offset is derived using a TM or BM based approach.

Clause 64. The method of clause 63, wherein the BV offset is shared by different colour components, or wherein the BV offset is different for different colour components.

Clause 65. The method of clause 51, wherein whether to add the BV offset is indicated in the bitstream.

Clause 66. The method of clause 65, wherein a syntax element is signalled to indicate whether the BV offset is used.

Clause 67. The method of clause 65, wherein one or more syntax elements are signalled to indicate the BV offset.

Clause 68. The method of clause 67, wherein the BV offset is equal to zero.

Clause 69. The method of clause 67, wherein a reordering is used to signal or derive the BV offset.

Clause 70. The method of clause 51, wherein a BV offset of one component is predicted by an BV offset of another component.

Clause 71. The method of any of clauses 1-70, wherein the chroma prediction derived using the one or more BVs is combined with other coding method.

Clause 72. The method of clause 71, wherein the other coding method comprises at least one of a traditional intra prediction mode, a cross-component linear mode (CCLM), a multi-mode linear mode (MMLM), a convolutional cross-component model (CCCM), a general linear mode (GLM), a decoder-side intra mode derivation (DIMD), a template-based intra mode derivation (TIMD), or an Intra TMP.

Clause 73. The method of clause 71, wherein the chroma prediction derived using the one or more BVs is combined with at least one of: an inter prediction mode, a bi-prediction with coding unit-level weight (BCW), a merge mode with motion vector difference (MMVD), a template matching (TM), an IBC, an affine, a decoder side motion vector refinement (DMVR), a multi-pass DMVR, a prediction refinement with optical flow (PROF), a bi-directional optical flow (BDOF), a sampled based BDOF, adaptive decoder-side motion vector refinement (ADMVR), an overlapped block motion compensation (OBMC), a TM based OBMC, a multi-hypothesis prediction (MHP), a geometric partition mode (GPM), a bilateral AMVP-merge mode, or a template matching AMVP-merge mode.

Clause 74. The method of clause 71, wherein the chroma prediction derived using the one or more BVs is combined with luma prediction or luma reconstruction.

Clause 75. The method of clause 71, wherein weights used for the combination are pre-defined, or the weights are indicated in the bitstream, or the weights are derived depending on coding information.

Clause 76. The method of clause 71, wherein whether to and/or an approach to combine the chroma prediction is indicated.

Clause 77. The method of 71, wherein whether to and/or an approach to combine the chroma prediction depends on coding information.

Clause 78. The method of clause 77, wherein whether to and/or an approach to combine the chroma prediction depends on whether combination is used for the collocated luma video unit.

Clause 79. The method of clause 77, wherein whether to and/or an approach to combine the chroma prediction depends on a sequence content.

Clause 80. The method of clause 71, wherein a high-level syntax (HLS) is signalled to indicate whether the combination is used.

Clause 81. The method of clause 71, wherein whether to and/or an approach to combine the chroma prediction is derived.

Clause 82. The method of clause 81. wherein TM based method is used in combining the chroma prediction.

Clause 83. The method of any of clauses 1-82, wherein a chroma BV of the video unit is used for following video units.

Clause 84. The method of clause 83, wherein the chroma BV of the video unit is stored.

Clause 85. The method of clause 83, wherein the chroma BV of current video unit is added in the HBVP table for chroma.

Clause 86. The method of clause 83, wherein the chroma BV of the video unit is used for a current block's processing.

Clause 87. The method of any of clauses 1-82, wherein the chroma BV of the video unit is not used for the following video units.

Clause 88. The method of any of clauses 1-87, wherein when IBC is used for the chroma prediction, a target coding tool is allowed to be used.

Clause 89. The method of clause 88, wherein the target coding tool comprises at least one of: an IBC-TM, an IBC merge mode with block vector differences (IBC-MBVD), a reconstruction-reordered IBC (RR-IBC), an IBC-IBC, an IBC-GPM, or an IBC-combined inter and intra prediction (IBC-CIIP).

Clause 90. The method of clause 89, wherein a syntax element is signalled in the bitstream to indicate whether the target coding tool is used for chroma prediction.

Clause 91. The method of clause 88, wherein a flip type of chroma RR-IBC block is inherited from a flip type of a luma block.

Clause 92. The method of clause 91, wherein the luma block is at least one of: a collocated luma block, spatial neighboring blocks of the collocated luma block, or a luma block which has a different position rather than the collocated one.

Clause 93. The method of clause 88, wherein a flip type of chroma RR-IBC block is independently determined.

Clause 94. The method of clause 88, wherein the target coding tool is used in dual tree, or wherein the target coding tool is used in single tree.

Clause 95. The method of any of clauses 1-87, wherein when IBC is used for the chroma prediction, a target coding tool is disallowed to be used.

Clause 96. The method of any of clauses 1-95, wherein the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

Clause 97. The method of any of clauses 1-95, wherein an indication of whether to and/or how to utilize the one or more BVs in the at least one BV candidate list for the chroma prediction of the video unit is indicated at one of the followings: sequence level, group of pictures level, picture level, slice level, or tile group level.

Clause 98. The method of any of clauses 1-95, wherein an indication of whether to and/or how to utilize the one or more BVs in the at least one BV candidate list for the chroma prediction of the video unit is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 99. The method of any of clauses 1-95, wherein an indication of whether to and/or how to utilize the one or more BVs in the at least one BV candidate list for the chroma prediction of the video unit is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 100. The method of any of clauses 1-95, further comprising: determining, based on coded information of the video unit, whether and/or how to utilize the one or more BVs in the at least one BV candidate list for the chroma prediction of the video unit, the coded information including at least one of: a block size, a colour format, a single and/or dual tree partitioning, a colour component, a slice type, or a picture type.

Clause 101. The method of any of clauses 1-100, wherein the conversion includes encoding the video unit into the bitstream.

Clause 102. The method of any of clauses 1-100, wherein the conversion includes decoding the video unit from the bitstream.

Clause 103. An apparatus for video processing comprising a processor and a non-transitory memory with instructions thereon, wherein the instructions upon execution by the processor, cause the processor to perform a method in accordance with any of clauses 1-102.

Clause 104. A non-transitory computer-readable storage medium storing instructions that cause a processor to perform a method in accordance with any of clauses 1-102.

Clause 105. A non-transitory computer-readable recording medium storing a bitstream of a video which is generated by a method performed by an apparatus for video processing, wherein the method comprises: constructing at least one block vector (BV) candidate list for a video unit of the video; utilizing one or more BVs in the at least one BV candidate list for a chroma prediction of the video unit; and generating the bitstream based on the chroma prediction of the video unit.

Clause 106. A method for storing a bitstream of a video, comprising: constructing at least one block vector (BV) candidate list for a video unit of the video; utilizing one or more BVs in the at least one BV candidate list for a chroma prediction of the video unit; generating the bitstream based on the chroma prediction of the video unit; and storing the bitstream in a non-transitory computer-readable medium.

### Example Device

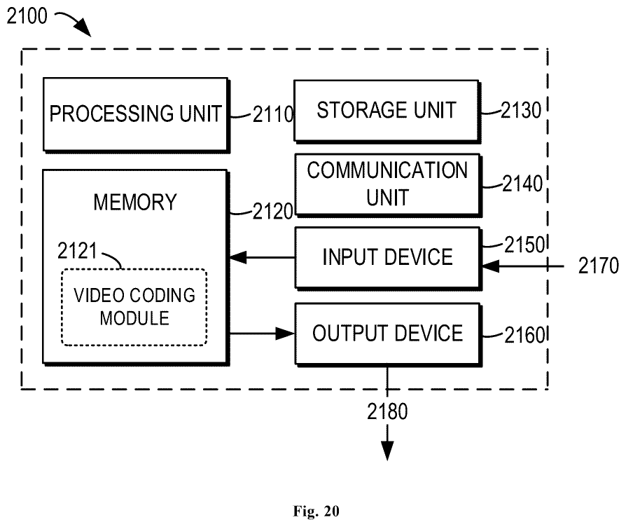

FIG. 20 illustrates a block diagram of a computing device 2100 in which various embodiments of the present disclosure can be implemented. The computing device 2100 may be implemented as or included in the source device 110 (or the video encoder 114 or 200) or the destination device 120 (or the video decoder 124 or 300).

It would be appreciated that the computing device 2100 shown in FIG. 20 is merely for purpose of illustration, without suggesting any limitation to the functions and scopes of the embodiments of the present disclosure in any manner.

As shown in FIG. 20, the computing device 2100 includes a general-purpose computing device 2100.

The computing device 2100 may at least comprise one or more processors or processing units 2110, a memory 2120, a storage unit 2130, one or more communication units 2140, one or more input devices 2150, and one or more output devices 2160.

In some embodiments, the computing device 2100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2100 can support any type of interface to a user (such as “wearable” circuitry and the like).

The processing unit 2110 may be a physical or virtual processor and can implement various processes based on programs stored in the memory 2120. In a multi-processor system, multiple processing units execute computer executable instructions in parallel so as to improve the parallel processing capability of the computing device 2100. The processing unit 2110 may also be referred to as a central processing unit (CPU), a microprocessor, a controller or a microcontroller.

The computing device 2100 typically includes various computer storage medium. Such medium can be any medium accessible by the computing device 2100, including, but not limited to, volatile and non-volatile medium, or detachable and non-detachable medium. The memory 2120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2130 may be any detachable or non-detachable medium and may include a machine-readable medium such as a memory, flash memory drive, magnetic disk or another other media, which can be used for storing information and/or data and can be accessed in the computing device 2100.

The computing device 2100 may further include additional detachable/non-detachable, volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2140 communicates with a further computing device via the communication medium. In addition, the functions of the components in the computing device 2100 can be implemented by a single computing cluster or multiple computing machines that can communicate via communication connections. Therefore, the computing device 2100 can operate in a networked environment using a logical connection with one or more other servers, networked personal computers (PCs) or further general network nodes.

The input device 2150 may be one or more of a variety of input devices, such as a mouse, keyboard, tracking ball, voice-input device, and the like. The output device 2160 may be one or more of a variety of output devices, such as a display, loudspeaker, printer, and the like. By means of the communication unit 2140, the computing device 2100 can further communicate with one or more external devices (not shown) such as the storage devices and display device, with one or more devices enabling the user to interact with the computing device 2100, or any devices (such as a network card, a modem and the like) enabling the computing device 2100 to communicate with one or more other computing devices, if required. Such communication can be performed via input/output (I/O) interfaces (not shown).

In some embodiments, instead of being integrated in a single device, some or all components of the computing device 2100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2100 may be used to implement video encoding/decoding in embodiments of the present disclosure. The memory 2120 may include one or more video coding modules 2125 having one or more program instructions. These modules are accessible and executable by the processing unit 2110 to perform the functionalities of the various embodiments described herein.

In the example embodiments of performing video encoding, the input device 2150 may receive video data as an input 2170 to be encoded. The video data may be processed, for example, by the video coding module 2125, to generate an encoded bitstream. The encoded bitstream may be provided via the output device 2160 as an output 2180.

In the example embodiments of performing video decoding, the input device 2150 may receive an encoded bitstream as the input 2170. The encoded bitstream may be processed, for example, by the video coding module 2125, to generate decoded video data. The decoded video data may be provided via the output device 2160 as the output 2180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
constructing, for a conversion between a video unit of a video and a bitstream of the video, at least one block vector (BV) candidate list for the video unit;
utilizing one or more BVs in the at least one BV candidate list for a chroma prediction of the video unit; and
performing the conversion based on the chroma prediction of the video unit.

2. The method of claim 1, wherein different chroma components share a same BV in the at least one BV candidate list.

3. The method of claim 2, wherein the different chroma components comprise Cb and Cr components.

4. The method of claim 1, wherein one or more default BVs in the at least one BV candidate list are used for the chroma prediction of the video unit.

5. The method of claim 1, wherein one or more BVs in the at least one BV candidate list are derived from a chroma component.

6. The method of claim 5, wherein one or more BVs of spatial neighboring video units of the video unit are used for the chroma prediction of the video unit.

7. The method of claim 5, wherein a history based block vector prediction (HBVP) table is constructed for chroma component.

8. The method of claim 5, wherein when neighboring video units are coded using a target mode, one or more derived BVs from the neighboring video units are used for the chroma prediction.

9. The method of claim 1, wherein one or more BVs of the at least one BV candidate list used for chroma component are derived from luma component.

10. The method of claim 1, wherein the one or more BVs are added to the at least one BV candidate list with different priorities.

11. The method of claim 1, wherein the at least one BV candidate list is reordered.

12. The method of claim 1, wherein a BV offset is added to the one or more BVs used for the chroma prediction.

13. The method of claim 12, wherein the BV offset or an index indicating the BV offset in an offset set is indicated in the bitstream, or
wherein the BV offset or the index indicating the BV offset in the offset set is derived.

14. The method of claim 1, wherein the chroma prediction derived using the one or more BVs is combined with other coding method.

15. The method of claim 14, wherein the other coding method comprises at least one of
a traditional intra prediction mode,
a cross-component linear mode (CCLM),
a multi-mode linear mode (MMLM),
a convolutional cross-component model (CCCM),
a general linear mode (GLM),
a decoder-side intra mode derivation (DIMD),
a template-based intra mode derivation (TIMD), or
an Intra TMP.

16. The method of claim 1, wherein a chroma BV of the video unit is used for following video units, and/or wherein when IBC is used for the chroma prediction, a target coding tool is allowed to be used.

17. The method of claim 1, wherein the conversion includes encoding the video unit into the bitstream, or wherein the conversion includes decoding the video unit from the bitstream.

18. An apparatus for video processing comprising a processor and a non-transitory memory with instructions thereon, wherein the instructions upon execution by the processor, cause the processor to perform:
construct, for a conversion between a video unit of a video and a bitstream of the video, at least one block vector (BV) candidate list for the video unit;
utilize one or more BVs in the at least one BV candidate list for a chroma prediction of the video unit; and
perform the conversion based on the chroma prediction of the video unit.

19. A non-transitory computer-readable storage medium storing instructions that cause a processor to perform:
construct, for a conversion between a video unit of a video and a bitstream of the video, at least one block vector (BV) candidate list for the video unit;
utilize one or more BVs in the at least one BV candidate list for a chroma prediction of the video unit; and
perform the conversion based on the chroma prediction of the video unit.

20. A non-transitory computer-readable recording medium storing a bitstream of a video which is generated by a method performed by an apparatus for video processing, wherein the method comprises:
constructing at least one block vector (BV) candidate list for a video unit of the video;
utilizing one or more BVs in the at least one BV candidate list for a chroma prediction of the video unit; and
generating the bitstream based on the chroma prediction of the video unit.
